(19) United States
(12) Patent Application Publication
(10) Pub. No.: US 2016/0073267 A1
(43) Pub. Date: Mar. 10, 2016

(54) Intelligence for Encoded Communication Data

(71) Applicant: Microsoft Corporation, Redmond, WA (US)

(72) Inventors: Amer A. Hassan, Kirkland, WA (US); Paul W. Garnett, Albany, NY (US); Paul William Alexander Mitchell, Seattle, NY (US)

(21) Appl. No.: 14/477,014

(22) Filed: Sep. 4, 2014

(51) Int. Cl. H04W 16/14; H04W 80/00

(52) U.S. Cl. CPC H04W 16/14; H04W 80/00

(57) ABSTRACT

Techniques for intelligence for encoded communication data are described. According to various implementations, a compatibility service is leveraged to provide intelligence regarding wireless technologies. Such intelligence may include identifiers for wireless technologies, interpretation information that enables communication data encoded according a particular technology to be decoded, and so forth. Embodiments, for instance, provide ways for enlightening various entities involved in wireless communication regarding wireless technologies.

### BACKGROUND

Many devices today utilize some form of wireless radio frequency (RF) data communication. A variety of different wireless technologies are available for wireless communication, including cellular, data broadband (e.g., Wi-Fi®), satellite-based communication, and so forth. Further, such technologies are typically implemented via a variety of different protocols and standards. For instance, different countries may implement a particular wireless technology based on differing standards. While such wireless variety provides for increased flexibility for different wireless scenarios, it also presents challenges for inter-device communication when devices utilize differing wireless technologies.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques for intelligence for encoded communication data are described. According to various implementations, a compatibility service is leveraged to provide intelligence regarding wireless technologies. Such intelligence may include identifiers for wireless technologies, interpretation information that enables communication data encoded according to a technology to be decoded, and so forth. Embodiments, for instance, provide ways for enlightening various entities involved in wireless communication regarding wireless technologies.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ techniques discussed herein in accordance with one or more embodiments.

FIG. 2 illustrates an example implementation scenario for intelligence for encoded communication data in accordance with one or more embodiments.

FIG. 3 is a flow diagram that describes steps in a method for obtaining intelligence regarding an unrecognized wireless technology in accordance with one or more embodiments.

FIG. 4 is a flow diagram that describes steps in a method for utilizing an executable to decode encoded communication data in accordance with one or more embodiments.

FIG. 5 is a flow diagram that describes steps in a method for providing intelligence regarding communication data in accordance with one or more embodiments.

FIG. 6 is a flow diagram that describes steps in a method for requesting decoding assistance in accordance with one or more embodiments.

FIG. 7 is a flow diagram that describes steps in a method for providing decoding assistance in accordance with one or more embodiments.

FIG. 8 illustrates an example system and computing device as described with reference to FIG. 1, which are configured to implement embodiments of techniques described herein.

### DETAILED DESCRIPTION

Overview

Techniques for intelligence for encoded communication data are described. According to various implementations, a compatibility service is leveraged to provide intelligence regarding wireless technologies. For instance, a client device may receive communication data via wireless communication that is encoded in an unrecognized encoding format such that the client device cannot decode the communication data. Accordingly, the client device queries a compatibility service with a sample of the communication data and requests intelligence regarding the communication data.

In response, the compatibility service matches the communication data with a known wireless technology (e.g., a wireless standard) that was used to encode the communication data. The compatibility service decodes the communication data according to a decoding scheme utilized by the wireless technology, and returns the decoded communication data to the client device. The decoded communication data, for instance, represents a bit stream of communication data, such as voice data, video data, content data, and so forth.

According to various implementations, a compatibility service provides intelligence regarding a wireless technology. For instance, in response to a query for intelligence regarding an unrecognized technology, the compatibility service matches the unrecognized technology to a known technology and returns an identifier for the known technology. Generally, the term “technology” as used herein refers to technologies involved in wireless communication. Examples of such technologies include cellular communications (e.g. 3G, 4G, Long Term Evolution (LTE), and so forth), near field communication (NFC), short-range wireless connections (e.g., Bluetooth), local area wireless networks (e.g., one or more standards in compliance with IEEE 802.11), wide area wireless networks (e.g., one or more standard in compliance with IEEE 802.16 or 802.22), wireless telephone networks, and so on.

In at least some implementations, the compatibility service may further provide interpretation information that enables communication data encoded according to the unrecognized technology to be decoded. Such interpretation information, for instance, may include a decoding scheme that is applicable to decode the communication data, executable code that is executable to decode the communication data, and so forth.

According to various implementations, a client device and/or other functionality may employ the interpretation information to decode communication data that is encoded in the previously unrecognized wireless technology. Thus, implementations discussed herein provide ways for enlightening various entities involved in wireless communication regarding unrecognized wireless technologies. In at least some implementations, such enlightenment promotes wireless interoperability between wireless devices that utilized different wireless technologies. For instance, implementations discussed herein enable wireless devices that utilized disparate wireless technologies to engage in wireless communication with one another, such as voice calls, Unified Communication (UC) sessions, content exchange, and so forth.

In the following discussion, an example environment is first described that is operable to employ techniques described herein. Next, a section entitled “Example Implementation Scenario” describes an implementation scenario involving techniques discussed herein which may be employed in the example environment as well as in other environments. Following this, a section entitled “Example Procedures” describes some example procedures for intelligence for encoded communication data in accordance with one or more embodiments. Finally, a section entitled “Example System and Device” describes an example system and device that are operable to employ techniques discussed herein in accordance with one or more embodiments.

Example Environment

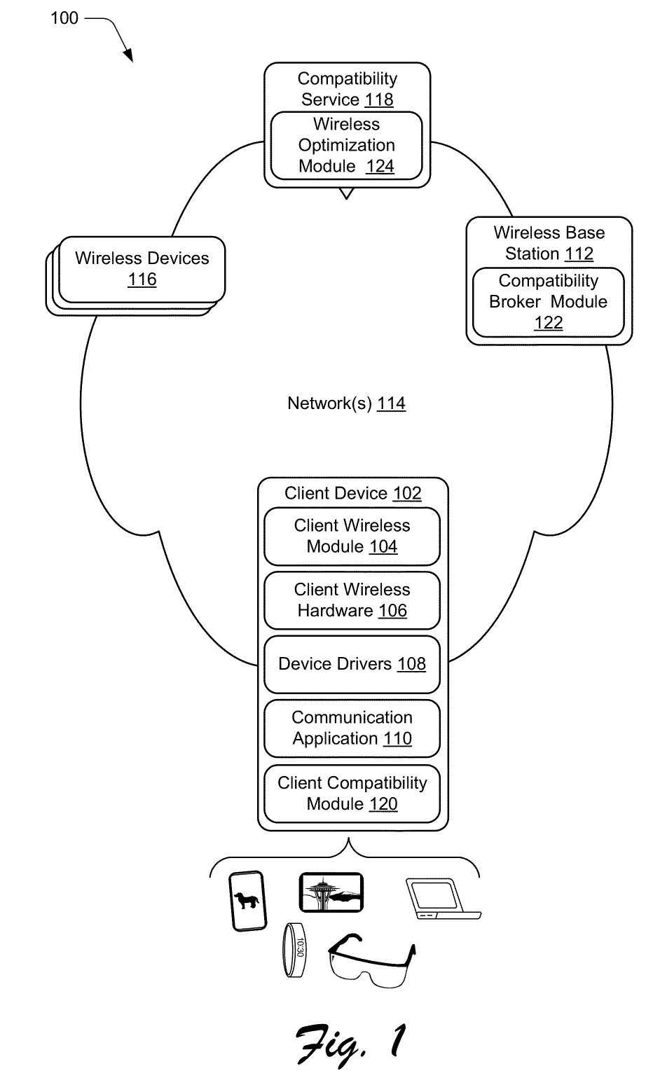

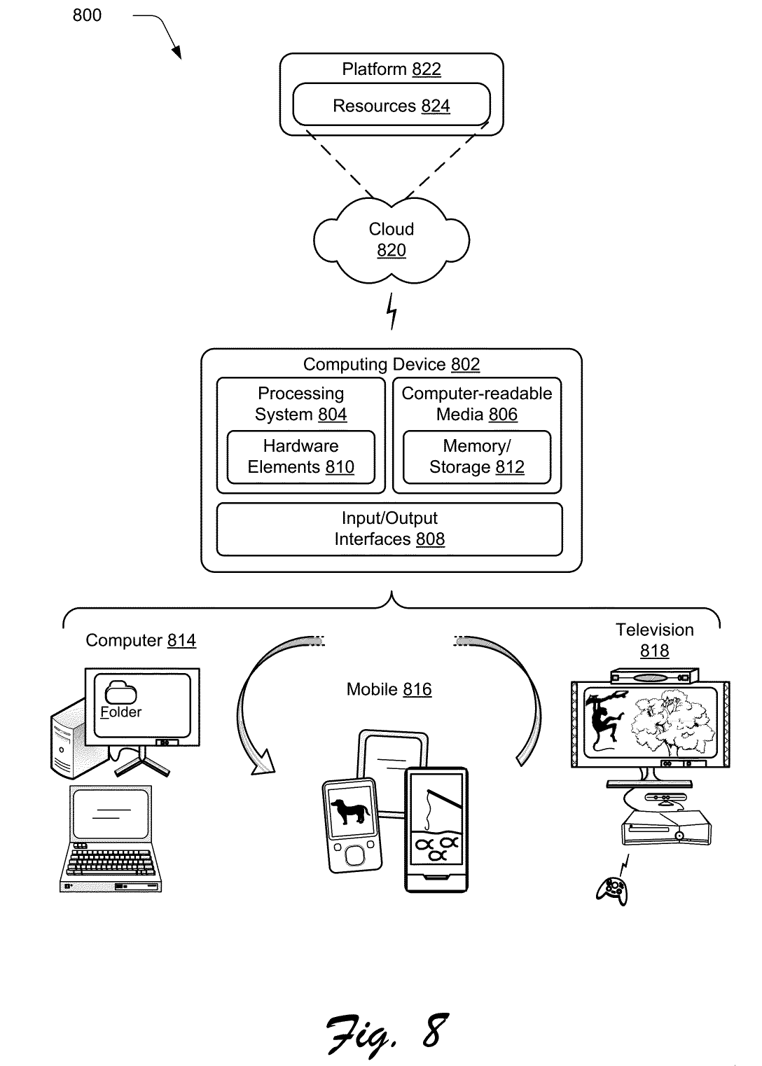

FIG. 1 is an illustration of an environment 100 in an example implementation that is operable to employ techniques for intelligence for encoded communication data. Generally, encoded communication data includes data transmitted via wireless communication, such as wireless broadband data, cellular data, data transmitted via satellites, and so forth. Environment 100 includes a client device 102 which can be embodied as any suitable device such as, by way of example and not limitation, a smartphone, a tablet computer, a portable computer (e.g., a laptop), a desktop computer, and so forth. One of a variety of different examples of a client device 102 is shown and described below in FIG. 8.

The client device 102 of FIG. 1 is illustrated as including a client wireless module 104, which is representative of functionality to enable the client device 102 to communicate wirelessly with other devices and/or entities. The client wireless module 104 can be configured to enable data communication via a particular wireless standard and/or protocol.

The client device 102 further includes client wireless hardware 106, which is representative of various hardware components that can be employed to enable the client device 102 to communicate wirelessly. Examples of the client wireless hardware 106 include radio transmitters, radio receivers, various types and/or combinations of antennas, impedance matching functionality, and so on. In at least some embodiments, the client device 102 is a multi-radio device that can communicate via different wireless technologies and/or protocols. For instance, the client wireless hardware 106 may include multiple antennas that are individually configured for different wireless technologies.

Further included as part of the client device 102 are one or more device drivers 108, which are representative of functionality to enable the client device 102 to interact with various devices, and vice-versa. For instance, the device drivers 108 can enable interaction between various functionalities of the client device 102 (e.g., an operating system, applications, services, and so on) and different devices of the client device 102, such as input/output (I/O) devices. The device drivers 108, for instance, can enable interaction between the client wireless module 104 and the client wireless hardware 106 to enable the client device 102 to transmit and receive wireless signals.

In at least some embodiments, the client device 102 is configured to communicate with other devices and/or entities via a communication application 110. Generally, the communication application 110 is representative of functionality to enable different forms of communication via the client device 102. Examples of the communication application 110 include a voice communication application (e.g., a Voice over Internet Protocol (VoIP) client), a video communication application, a messaging application, a content sharing application, a Unified Communications (UC) application, and combinations thereof. The communication application 110, for instance, enables different communication modalities to be combined to provide diverse communication scenarios.

The environment 100 further includes a wireless base station 112, which is representative of a radio receiver and transmitter that serves as a hub for at least some wireless portions of network(s) 114. In at least some embodiments, the wireless base station 112 may serve as a gateway between wired and wireless portions of the network(s) 114. The wireless base station 112 may be implemented in various ways, such as a cellular base station, a wireless broadband access point, a satellite base station, and so forth.

Generally, the network 114 is representative of a single network or a combination of different interconnected networks. In at least some implementations, the network 114 represents different portions of the radio spectrum that may be leveraged for wireless communication. The network 114, for instance, represents radio spectrum in different frequency bands, such as ultra-high frequency (UHF), super-high frequency (SHF), and so forth. The network 114 may also represent a combination of wireless and wired networks and may be configured in a variety of ways, such as a cellular network, a wide area network (WAN), a local area network (LAN), the Internet, and so forth.

According to various implementations, techniques for intelligence for encoded communication data discussed herein can be employed to enable wireless data communication between the client device 102 and other wireless devices 116 utilizing a variety of different wireless data communication technologies, standards, and protocols. For instance, consider a scenario where the wireless device 116 is configured to transmit and receive wireless data via a particular wireless technology that the client device 102 is not configured to decode, e.g., that is not interoperable with the client device 102. In such a scenario, a compatibility service 118 may be leveraged to enable interoperability between the wireless device 116 and the client device 102.

Generally, the compatibility service 118 is representative of a network service (e.g., a cloud-based service) that provides various wireless interoperability and optimization services to different wireless devices, such as the client device 102, the wireless base station 112, the wireless devices 116, and so forth. For example, interaction between a client compatibility module 120 of the client device 102, a compatibility broker module 122 of the wireless base station 112, and a wireless optimization module 124 of the compatibility service 118 may enable wireless data transmitted by the wireless device 116 to be decoded according to a particular wireless technology utilized by the wireless device 116 such that the wireless data may be understood by the client device 102. Further implementation details and operational parameters of the various entities of the environment 100 are discussed below.

Having described an example environment in which the techniques described herein may operate, consider now a discussion of an example implementation scenario in accordance with one or more embodiments.

Example Implementation Scenario

The following discussion describes an example implementation scenario for intelligence for encoded communication data in accordance with one or more embodiments. In portions of the following discussion, reference will be made to the environment 100 of FIG. 1.

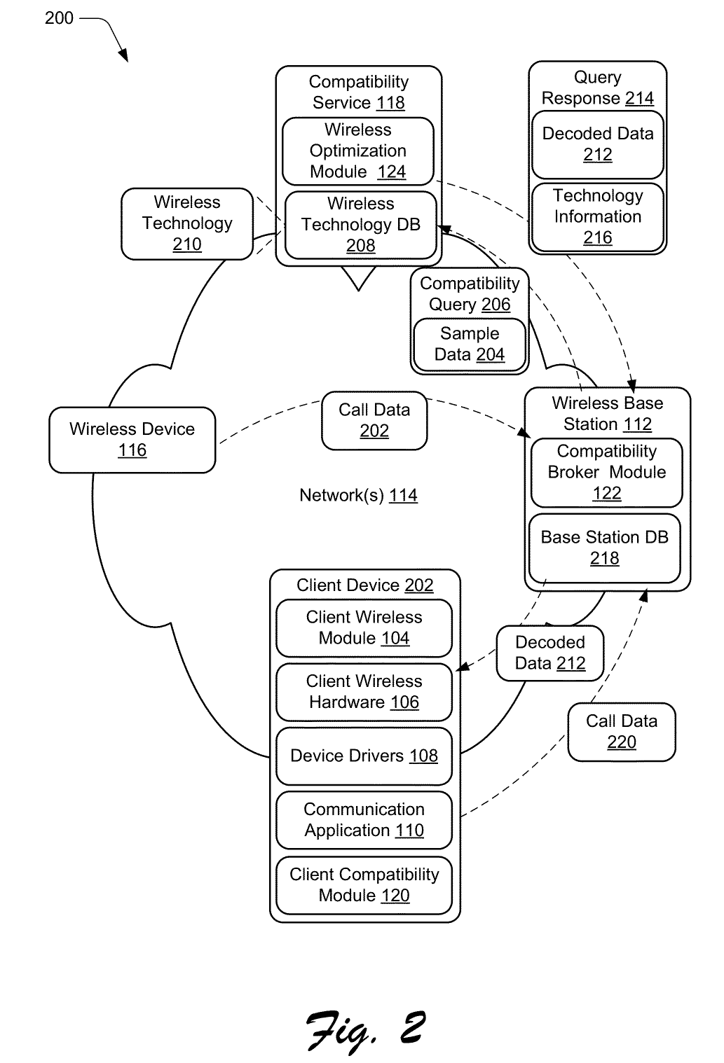

FIG. 2 illustrates an example implementation scenario 200 for enabling communication between wireless devices that utilize disparate wireless technologies in accordance with one or more embodiments.

In the scenario 200, a user of the wireless device 116 performs an action to initiate a communication session with the client device 102. The user, for instance, dials a telephone number, selects a contact, selects a hyperlink, and so forth, that corresponds to the client device 102. The communication session may be implemented as various types of communication events, such as a cellular call, a satellite call, a VoIP call, a UC call, and so forth. Accordingly, call data 202 is communicated from the wireless device 116 via the network 114 to the wireless base station 112. The call data 202 may be implemented in various ways, such as an association request, a request to initiate a cellular call, a session initiation request, and so forth. Although not illustrated here, the call data 202 may be routed through one or more intermediate functionalities along a routing path to the wireless base station 112, such as other base stations, other networks, and so forth.

Further to the scenario 200, the wireless base station 112 attempts to decode the call data 202 but determines that the call data 202 is formatted according to a wireless technology that is not recognized by the wireless base station 112. For instance, the call data 202 is received as wireless signal, and the wireless base station 112 performs analog-to-digital (A/D) conversion on the wireless signal to generate bits of encoded data. The wireless base station 112 attempts to decode the bits but determines that the bits are encoded in a format that is unrecognized by the wireless base station 112. Accordingly, the wireless base station 112 processes the call data 202 and generates sample data 204 that includes sample data from the call data 202. The sample data 204, for instance, includes bits of encoded data generated via A/D conversion of the call data 204.

The wireless base station 112 communicates the sample data 204 to the compatibility service 118 as part of a compatibility query 206. According to various implementations, the compatibility query 206 specifies that the sample data 204 is formatted according to a technology that is unrecognized by the wireless base station 112, and requests that the compatibility service 118 provide intelligence regarding the sample data 204.

In at least some implementations, the compatibility query 206 is generated and communicated to the compatibility service 118 by the compatibility broker module 122. For instance, the compatibility broker module 122 retrieves the sample data 204 from wireless functionality of the wireless base station 112, and generates the compatibility query 206 to include the sample data 204.

Continuing with the scenario 200, the compatibility service 118 receives the compatibility query 206 and parses the query to ascertain various information and parameters included therein. For instance, the wireless optimization module 124 ascertains that the compatibility query 206 includes the sample data 204 and requests intelligence regarding the sample data. The compatibility query 206, for instance, indicates that the sample data 204 was received as part of a wireless communication and is formatted according to a wireless technology that is unrecognized by the wireless base station 112.

Accordingly, the wireless optimization module 124 performs technology matching in an attempt to identify a technology that was used to encode the sample data 204. For instance, the wireless optimization module 124 includes a wireless technology database (DB) 208 that includes attributes of different wireless technologies. Examples of such attributes are discussed below. Generally, the wireless technology DB 208 maps attributes of wireless data to corresponding wireless technologies used to generate the wireless data. Thus, the wireless optimization module 124 compares attributes of the sample data 204 to the wireless technology DB 208 to identify a wireless technology used to generate the sample data 204.

Further to the scenario 200, the wireless optimization module 124 identifies a particular wireless technology 210 used to generate the sample data 204. The wireless optimization module 124 then decodes the sample data 204 according to the wireless technology 210 to generate decoded data 212. The decoded data 212, for instance, represents data that is understandable to the wireless base station 112 and/or the client device 102.

Accordingly, the wireless optimization module 124 generates a query response 214 that includes the decoded data 212 and technology information 216 about the wireless technology 210. The technology information 216, for instance, includes an identifier for the wireless technology 210. In at least some implementations, the technology information 216 includes guidance for interpretation (e.g., decoding) of data formatted (e.g., encoded) according to the wireless technology 210. For instance, the technology information 216 may include attributes of the wireless technology 210, such as an encoding and/or decoding algorithm, a spectrum pattern, a modulation method, and so forth.

In at least some implementations, the wireless technology DB 208 may include and/or identify an executable (e.g., executable code) that may be used to decode and/or interpret data that is encoded according to the wireless technology 210. In such implementations, the wireless optimization module 124 may include the executable as part of the technology information 216.

The compatibility service 118 communicates the query response 214 to the wireless base station 112. The compatibility broker module 122 then parses the query response to retrieve the decoded data 212 and ascertain the technology information 216. According to various implementations, the technology information 216 may be used in various ways. For instance, the compatibility broker module 122 may store the technology information 216 as part of a base station database (DB) 218 that includes information about different wireless technologies. According to various implementations, the wireless base station 112 may utilize information from the base station DB 218 to identify, interpret, and/or decode wireless data that is received from different wireless devices 116. As referenced above, for instance, the technology information 216 may identify attributes of the wireless technology 210 that may be utilized to decode data that is encoded according to the wireless technology 210, such as an encoding/decoding algorithm.

Alternatively or additionally, the technology information 216 may include an executable that may be leveraged to decode data that is encoded according to the wireless technology 210. For instance, the executable may be installed on the wireless base station 112 such that wireless data received from the wireless device 116 can be decoded into a bit stream that is understandable to the wireless base station 112 and the client device 102.

Further to the scenario 200, the wireless base station 112 communicates the decoded data 212 to the client device 102. As indicated above, the decoded data 212 is in a format that is understood by the client device 102, such as a decoded bit stream that represents a portion of communication data from the wireless device 116 addressed to the client device 102.

According to various implementations, the wireless base station 112 may utilize the technology information 216 to decode subsequent call data from the wireless device 116 into a decoded bit stream, which is communicated to the client device 102 as part of a communication session. For instance, communication between the wireless base station 112 and the compatibility service 118 such as described above is effective to configure the wireless base station 112 to decode call data from the wireless device 116. Thus, in at least some implementations, subsequent call data received from the wireless device 116 may be decoded and communicated to the client device 102 without requiring further interaction with the compatibility service 118.

Alternatively or additionally, aspects of the scenario 200 may leveraged to provide a variety of different operating scenarios and alternatives. For instance, the compatibility service 118 may operate as an interpretation service that converts call data from the wireless device 116 into a format that is compatible with the wireless base station 112 and the client device 102. As the call data is received by the wireless base station 112, for example, the wireless base station 112 may submit the call data to the compatibility service 118 to be decoded. The compatibility service 118 then communicates decoded call data to the wireless base station 112, which then forwards the decoded call data to the client device 102. This process may be performed in real-time during a communication session to enable communication between the wireless device 116 and the client device 102.

As another example scenario, the wireless base station 112 may propagate the technology information 216 to the client device 102 such that the client device 102 may configure itself with functionality to decode further call data from the wireless device 116. For instance, in implementations where the technology information 216 includes an executable, the executable may be installed on the client device 102 to enable the client device 102 to decode call data encoded according to the wireless technology 210.

As a further example variation, interactions between the wireless base station 112 and the compatibility service 118 described above may alternatively or additionally occur between the client device 102 (e.g., via the client compatibility module 120) and the compatibility service 118. For instance, the call data 202 may be routed to the client device 102 via the wireless base station 112. The client device 102 then determines that the call data 202 is formatted according to an unrecognized technology. Accordingly, the client device 102 generates and submits the compatibility query 206 to the compatibility service 118. In response to the compatibility query 206, the compatibility service generates the query response 214 and communicates the query response 214 to the client device 102. The client device 102 may then utilize the technology information 216 to configure itself to interpret and decode call data formatted according to the wireless technology 210. For instance, further call data received by the client device 102 from the wireless device 116 may be decoded by the client device 102, such as independent of further interaction with the compatibility service 118.

According to various implementations, call data 220 generated by the client device 102 and addressed to the wireless device 116 may be converted from a native wireless technology of the client device 102 into the wireless technology 210 utilized by the wireless device 116. For instance, the call data 220 may be initially encoded by the client device 102 according to a native encoding scheme utilized by the client device 102. The call data 220 may then be decoded and re-encoded according to the wireless technology 210. Such re-encoding may be performed by the client device 102 (e.g., via the client compatibility module 120), and/or the compatibility broker module 122 of the wireless base station 112. The technology information 216, for instance, may include logic that may be leveraged by the client device 102 and/or the wireless base station 112 to perform encoding according to the wireless technology 210.

As referenced above and in some alternative or additional implementations, the compatibility service 118 may be leveraged as a conversion service for converting wireless data between different technologies. For instance, the call data 220 from the client device 102 may be converted by the compatibility service 118 from a native technology of the client device into the wireless technology 210. The compatibility service 118 may then communicate the converted call data for receipt by the wireless device 116, such as via the wireless base station 112.

According to various implementations, the scenario 200 and its variations and alternatives may be implemented in real-time, e.g., in response to a request by the wireless device 116 to engage in a communication session with the client device 102. For instance, technology conversion of call data between the wireless device 116 and the client device 102 may be performed in real-time as part of call initiation and/or while a call is in progress.

Having discussed an example implementation scenario, consider now some example procedures in accordance with one or more embodiments.

Example Procedures

Discussed below are some example procedures for intelligence for encoded communication data in accordance with various implementations. The procedures, for instance, describe example ways of implementing various aspects of the implementation scenarios described above.

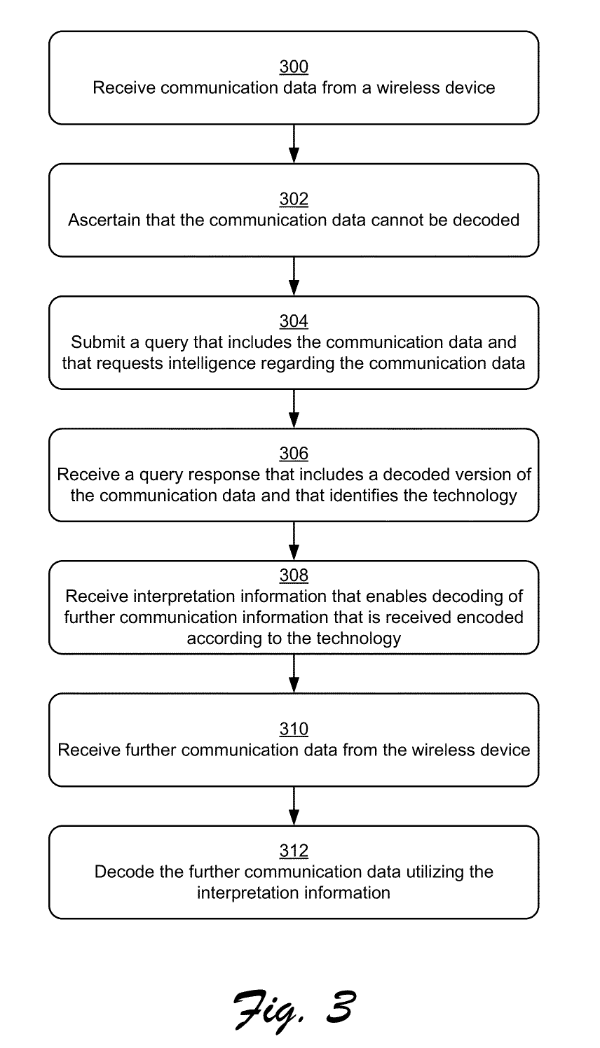

FIG. 3 is a flow diagram that describes steps in a method for obtaining intelligence regarding an unrecognized wireless technology in accordance with one or more embodiments. Various aspects of the method may be performed by the wireless base station 112 and/or the client device 102.

Step 300 receives communication data from a wireless device. The communication data, for instance, is received as part of a wireless communication session (e.g., a call) initiated and/or to be initiated between a wireless device and a client device. The communication data may be received in various forms, such as data that represents output from an analog-to-digital conversion of samples of analog data (e.g., from a wireless device 116), a bit stream of communication data, and/or combinations thereof.

Step 302 ascertains that the communication data cannot be decoded. The communication data, for instance, is encoded according to a technology that is unrecognized. For example, wireless communication data is converted from wireless signal (e.g., a passband signal) into digital data (e.g., baseband signal), and the digital data is determined to be encoded according to an incompatible and/or unrecognized encoding format. With reference to the wireless base station 112 and/or the client device 102, for instance, an attempt to decode the digital data based on a native wireless technology fails. For example, an attempt to decode digital data obtained from the communication data using a native encoding scheme produces unusable data.

Step 304 submits a query that includes the communication data and that requests intelligence regarding the communication data. The query, for instance, includes a sample of the communication data (e.g., a sample bit stream) and requests information about a technology used to encode the communication data. One example of such a query is discussed above with reference to the compatibility query 206.

Step 306 receives a query response that includes a decoded version of the communication data and that identifies the technology. The query response 214 discussed above represents one example of such a query response.

Step 308 receives interpretation information that enables decoding of further communication information that is received encoded according to the technology. In at least some implementations, the interpretation information is received as part of the query response referenced above. Alternatively or additionally, the interpretation information may be received separately, such as part of a separate query for interpretation information for the technology. For instance, subsequent to an identifier for the technology being received as discussed above, a separate query may be communicated that identifies the technology and requests interpretation information for the technology.

The interpretation information may be implemented in various ways, such as an encoding and/or decoding algorithm that enables encoding and decoding of communication information that is encoded according to the technology. In another example, the interpretation information includes an executable (e.g., an executable program) that is executable to decode communication data encoded according to the technology. In at least some implementations, the executable may additionally be executed to encode data from another technology into data that is encoded according to the identified technology.

Step 310 receives further communication data from the wireless device. The further communication data, for instance, is encoded according to the technology identified above.

Step 312 decodes the further communication data utilizing the interpretation information. For instance, a decoding algorithm identified by the interpretation information is applied to decode the further communication information. Alternatively or additionally, an executable included as part of the interpretation information is executed to decode the further communication data. The executable, for instance, is installed on a receiving device, such as the client device 102, the wireless base station 112, and so forth. In response to receiving the further communication data, the executable is executed to decode the further communication data, such as automatically and in response to detecting the further communication data.

In at least some implementations, the interpretation information may include logic for encoding data from another technology into data encoded according to the identified technology. For instance, the interpretation information may enable the client device 102 and/or the wireless base station 112 to encode data according to a wireless technology that is different than their native wireless technology, e.g., according to a wireless technology implemented by the wireless device 116. Such implementations enable data encoded by the wireless device 116 to be successfully decoded by the client device 102, and further enable the client device 102 to encode communication data according to the technology employed by the wireless device 116. Thus, implementation discussed herein enable communication data to be exchanged and understood between devices that employ differing encoding technologies.

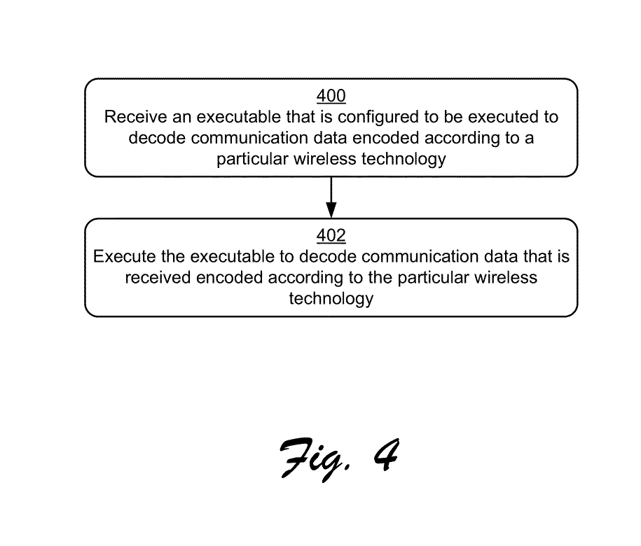

FIG. 4 is a flow diagram that describes steps in a method for utilizing an executable to decode encoded communication data in accordance with one or more embodiments. In at least some implementations, the method may be performed by the client device 102 and/or the wireless base station 112.

Step 400 receives an executable that is configured to be executed to decode communication data encoded according to a particular wireless technology. The executable, for instance, is received as part of the query response 214 discussed herein.

Step 402 executes the executable to decode communication data that is received encoded according to the particular wireless technology. The executable, for instance, is installed on a receiving device, such as the client device 102, the wireless base station 112, and so forth. Thus, when communication data is received that is encoded according to the particular wireless technology, the installed executable can be invoked to decode the communication data. The executable, for instance, may be invoked automatically and in response to detecting that communication data is received that is encoded according to the particular technology.

According to one or more implementations, the executable represents baseband processing logic. For instance, when wireless RF signal including communication data is received, the wireless signal is converted to baseband signal. The executable is then executed to decode the baseband signal to produce decoded communication data, e.g., a digital bit stream of communication data.

In at least some implementations, the executable may be associated with an expiration data after which the executable is no longer effective. For instance, the executable may be have a license period after which the executable is no longer effective to decode communication data. According to one or more implementations, the license period may be renewed, such as for a fee. The executable, for instance, may be made available based on a subscription model that provides access to the executable in exchange for a one-time and/or periodic fee.

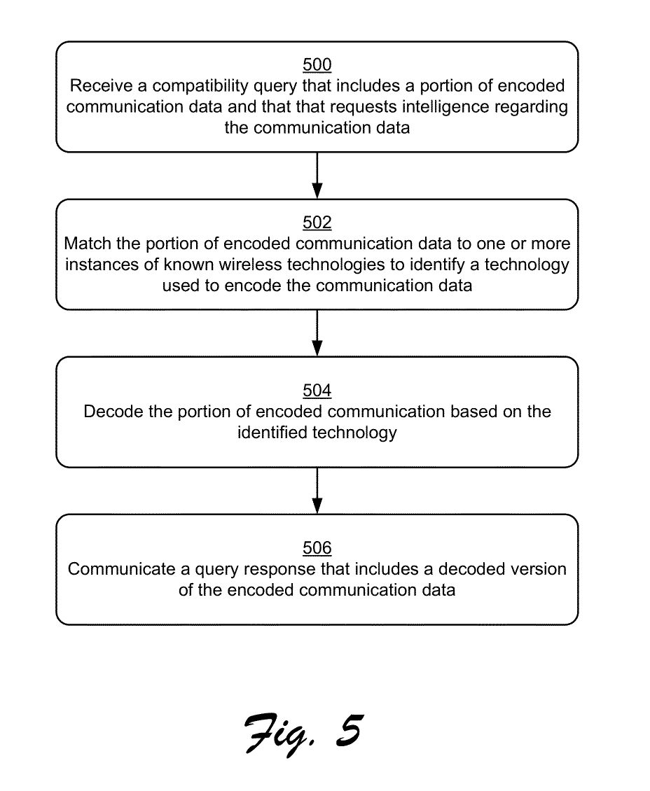

FIG. 5 is a flow diagram that describes steps in a method for providing intelligence regarding communication data in accordance with one or more embodiments. In at least some implementations, the method may be performed by the compatibility service 118.

Step 500 receives a compatibility query that includes a portion of encoded communication data and that that requests intelligence regarding the communication data. The compatibility query, for instance, requests identification of a technology used to encode the communication data. In at least some implementations, the compatibility query requests interpretation information to enable decoding of the communication data. The compatibility query 206 discussed above represents one example of such a compatibility query.

Step 502 matches the portion of encoded communication data to one or more instances of known wireless technologies to identify a technology used to encode the communication data. Any suitable technology matching technique may be employed according to various implementations. For instance, the received encoded communication data may include a spectrum profile that identifies RF frequencies used to transmit the communication data. Accordingly, spectrum matching may be performed that compares the spectrum profile to spectrum profiles for known wireless technologies. A spectrum profile for a known wireless technology that most closely matches the spectrum profile of the encoded communication data may be identified as the technology used to encode the communication data.

In another example, modulation matching may be performed between the received communication data and modulation for known wireless technologies. For instance, characteristics of the communication data and/or the wireless signal used to transmit the communication data may be compared to characteristics of modulation methods for known wireless technologies. A known wireless technology whose modulation technique best matches that of the received communication data may be identified as the technology used to encode the communication data. In at least some implementations, spectrum matching and modulation matching may be combined to provide improved technology matching performance. These technology matching techniques are presented for purpose of example only, and it is to be appreciated that a variety of other technology matching techniques may be employed in accordance with the described implementations.

Step 504 decodes the portion of encoded communication based on the identified technology. The compatibility service 118, for instance, applies a decoding algorithm utilized by the identified technology to the portion of the encoded communication.

Step 506 communicates a query response that includes a decoded version of the encoded communication data. The query response 214 discussed above represents one example of such a query response. According to various implementations, the query response further includes an identifier for the identified technology. For instance, the query response may indicate a general identifier for the technology, such as “LTE.” Additionally, the query response may further identify a version, standard, and/or release number for the technology, such as “Time-Division (TD) LTE,” “Frequency-Division (FD) LTE,” “LTE Release 8,” and so forth. The LTE technology is used for purpose of example only, and it is to be appreciated that techniques discussed herein may be employed with any suitable wireless technology.

In at least some implementations, communication data decoding may be performed in real-time to provide a stream of decoded communication data. For instance, the client device 102 and/or the wireless base station 112 may stream encoded communication data to the compatibility service 118, which then decodes the communication data and streams the decoded communication data back to the wireless base station 112 and/or the client device 102. Such streaming decoding may be performed for some or all portions of a communication session, such as for session initiation, session performance, session termination, and so forth. For example, as an alternative or addition to providing decoding intelligence to the wireless base station 112 and/or the client device 102, the compatibility service 118 may serve as a remote decoding service that receives encoded communication data, decodes the communication data, and returns the decoded communication data.

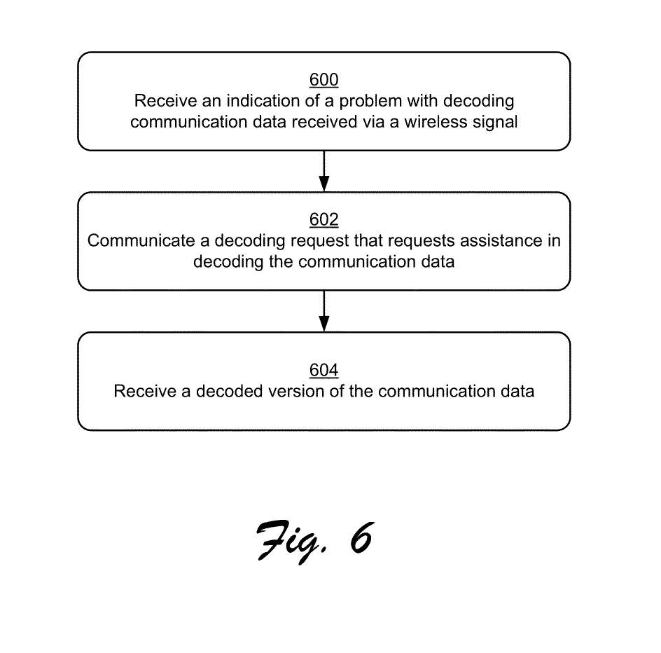

FIG. 6 is a flow diagram that describes steps in a method for requesting decoding assistance in accordance with one or more embodiments. In at least some implementations, the method may be performed by the client device 102 and/or the wireless base station 112.

Step 600 receives an indication of a problem with decoding communication data received via a wireless signal. The communication data, for instance, may include errors that make decoding the communication data difficult or impossible. Additionally or alternatively, a signal-to-noise ratio (S/N) of the wireless signal may be below a S/N threshold such that the communication data cannot be decoded. According to various implementations, the client compatibility module 120 and/or the compatibility broker module 122 may detect the problem, such as based on interaction with wireless functionality of the client device 102 and/or the wireless base station 112.

Step 602 communicates a decoding request that requests assistance in decoding the communication data. The decoding request, for instance, includes the communication data and requests assistance in decoding the communication data. According to various implementations, the decoding request may be communicated by the client device 102 and/or the wireless base station 112 to the compatibility service 118.

Step 604 receives a decoded version of the communication data. The decoded version, for instance, represents a decoded digital bit stream of communication data, such as voice data, video data, messaging, content, and so forth.

According to various implementations, the method may be performed for communication data that is received according to a recognized encoding technology. For instance, the encoding technology may be known but the quality of the communication data may be so low that decoding the communication data is difficult (e.g., resource-intensive) or impossible. In at least some implementations, the method may be performed subsequent to the methods described above for receiving intelligence regarding an unrecognized technology.

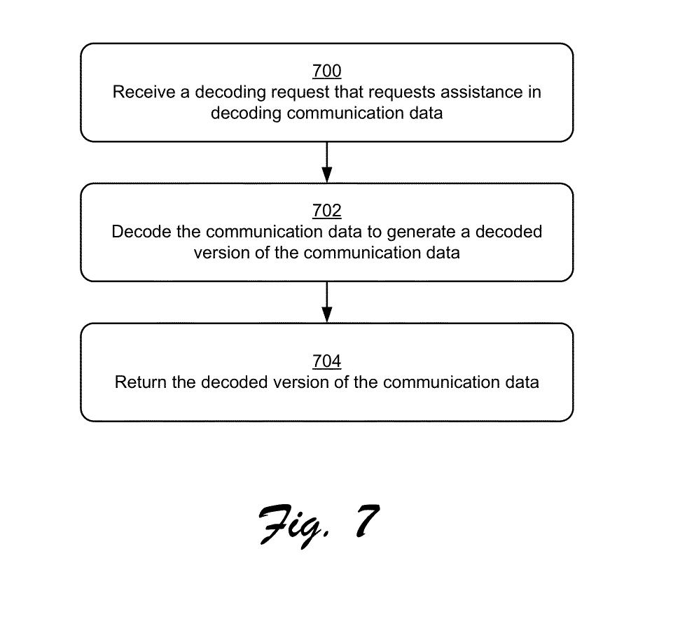

FIG. 7 is a flow diagram that describes steps in a method for providing decoding assistance in accordance with one or more embodiments. In at least some implementations, the method may be performed by the compatibility service 118.

Step 700 receives a decoding request that requests assistance in decoding communication data. The decoding request, for instance, includes encoded and/or partially decoded communication data, and requests assistance in decoding the communication data. According to various implementations, the decoding request is received by the compatibility service 118 from the client device 102 and/or the wireless base station 112.

Step 702 decodes the communication data to generate a decoded version of the communication data. The wireless optimization module 124, for instance, decodes the communication data using one or more decoding algorithms and/or decoding procedures.

Step 704 returns the decoded version of the communication data. The compatibility service 118, for instance, communicates the decoded communication data to the wireless base station 112 and/or the client device 102. Thus, the compatibility service 118 may serve as a wireless optimization service that provides assistance in data decoding and/or processing.

In at least some implementations, the procedures discussed above may be implemented in real-time, such as part of initiation of a communication session, during a communication session, and so forth. Alternatively or additionally, the procedures may be implemented proactively, such as prior to initiation of a communication session to enable a device to be proactively configured to successfully decode and/or encode communication data according to a non-native encoding technology.

Having discussed some example procedures, consider now a discussion of an example system and device in accordance with one or more embodiments.

Example System and Device

FIG. 8 illustrates an example system generally at 800 that includes an example computing device 802 that is representative of one or more computing systems and/or devices that may implement various techniques described herein. For example, the client device 102, the wireless device 116, and/or the wireless base station 112 discussed above with reference to FIG. 1 can be embodied as the computing device 802. The computing device 802 may be, for example, a server of a service provider, a device associated with the client (e.g., a client device), an on-chip system, and/or any other suitable computing device or computing system.

The example computing device 802 as illustrated includes a processing system 804, one or more computer-readable media 806, and one or more I/O Interfaces 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 806 is illustrated as including memory/storage 812. The memory/storage 812 represents memory/storage capacity associated with one or more computer-readable media. The memory/storage 812 may include volatile media (such as random access memory (RAM)) and/or nonvolatile media (such as read only memory (ROM), Flash memory, optical disks, magnetic disks, and so forth). The memory/storage 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone (e.g., for implementing voice and/or spoken input), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent storage of information in contrast to mere signal transmission, carrier waves, or signals per se. Computer-readable storage media do not include signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of modules discussed herein as software may be achieved at least partially in hardware, e.g., through use of computer-readable storage media and/or hardware elements 810 of the processing system. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. For example, functionalities discussed with reference to the client device 102, the wireless base station 112, and/or the compatibility service 118 may be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi™ network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

Discussed herein are a number of methods that may be implemented to perform techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods can be implemented via interaction between various entities discussed above with reference to the environment 100.

### CONCLUSION

Techniques for intelligence for encoded communication data are described. Although embodiments are described in language specific to structural features and/or methodological acts, it is to be understood that the embodiments defined in the appended claims are not necessarily limited to the specific features or acts described. Rather, the specific features and acts are disclosed as example forms of implementing the claimed embodiments.

1. A system comprising:
one or more processors; and
one or more computer-readable storage media storing computer-executable instructions that are executable by the one or more processors to perform operations including:
ascertaining that communication data received from a wireless device is formatted according to a wireless technology that is unrecognized by the system;
submitting a query that includes:
at least some of the communication data; and
a request for intelligence regarding the communication data including an identifier for the wireless technology that is unrecognized by the system; and
receiving a query response that includes a decoded version of the at least some of the communication data and an identifier for the wireless technology.

2. A system as described in claim 1, wherein the communication data is received as part of call data of a call between the wireless device and a client device, and wherein the operations are performed in real-time while the call is in progress.

3. A system as described in claim 1, wherein the communication data is received as data that represents output from an analog-to-digital conversion of samples of analog data.

4. A system as described in claim 1, wherein the system comprises at least one of:
a wireless base station; or
a client device that receives the communication data from the wireless device.

5. A system as described in claim 1, wherein the query response further includes interpretation information configured to enable further communication data that is received encoded according to the particular wireless technology to be decoded.

6. A system as described in claim 1, wherein the query response further includes interpretation information for the particular wireless technology, and the operations further include:
receiving further communication data from the wireless device; and
decoding the further communication data utilizing the interpretation information.

7. A system as described in claim 6, wherein the operations further include:
receiving an indication of a problem with decoding the further communication data;
communicating, to a network-based service, a decoding request that includes the further communication data and that requests assistance in decoding the further communication data; and
receiving a decoded version of the further communication data from the network-based service.

8. A system as described in claim 1, wherein the query response further includes an executable that is installable to enable further communication data that is received encoded according to the particular wireless technology to be decoded.

9. A computer-implemented method comprising:
receiving a compatibility query that includes:
a portion of encoded communication data; and
a request for intelligence regarding the communication data including an identifier for the wireless technology used to encode the communication data;
matching the portion of encoded communication data to one or more instances of known wireless technologies to identify a technology used to encode the communication data; and
communicating a query response that includes a decoded version of the encoded communication data and one or more of:
an identifier for the wireless technology used to encode the communication data; or
interpretation information that enables communication data encoded according to the wireless technology used to encode the communication data to be decoded.

10. The computer-implemented method as described in claim 9, wherein said matching comprises performing at least one of spectrum matching or modulation matching between the portion of encoded communication data and the one or more instances of known wireless technologies.

11. The computer-implemented method as described in claim 9, wherein the interpretation information includes a decoding algorithm that is applicable to decode further communication data that is encoded according to the identified technology.

12. The computer-implemented method as described in claim 9, wherein the interpretation information includes an executable that is configured to be executed to decode further communication data that is encoded according to the identified technology.

13. The computer-implemented method as described in claim 9, wherein the encoded communication data comprises a portion of call data of a call, and wherein said communicating comprises communicating the query response for receipt by a wireless base station involved in the call.

14. The computer-implemented method as described in claim 9, wherein the encoded communication data comprises a portion of call data of a call, and wherein said communicating comprises communicating the query response for receipt by a client device involved in the call.

15. The computer-implemented method as described in claim 9, further comprising:
receiving at a network-based service a decoding request that requests assistance in decoding a further portion of communication data;
decoding the further portion of communication data to generate a decoded version of the further portion of communication data; and
returning the decoded version of the further portion of the communication data.

16. A computer-implemented method comprising:
submitting a query that includes:
communication data received from a wireless device that is formatted according to a wireless technology that is unrecognized; and
a request for intelligence regarding the communication data including an identifier for the wireless technology;
receiving a query response that includes a decoded version of the communication data and interpretation information for a technology used to encode the communication data including an identifier for the wireless technology; and
decoding further communication data received from the wireless device utilizing the interpretation information.

17. The computer-implemented method as described in claim 16, wherein the communication data comprises a portion of a call between the wireless device and a client device, and wherein the further communication data comprises a further portion of the call.

18. The computer-implemented method as described in claim 16, wherein the interpretation information further comprises a decoding algorithm that is configured to be applied to decode the further communication data.

19. The computer-implemented method as described in claim 16, wherein the interpretation information further comprises an executable that is configured to be executed to decode the further communication data.

20. The computer-implemented method as described in claim 16, wherein the interpretation information further comprises an executable that is configured to be executed to decode the further communication data, and wherein the method further comprises causing the executable to be installed on a client device to enable the client device to perform said decoding.
